(19) United States
(12) Patent Application Publication
(10) Pub. No.: US 2013/0032502 A1
(43) Pub. Date: Feb. 7, 2013

(54) Ornamentally Variable Portable Container for Personal Items

(71) Applicants: Seth Anderson, Fort Worth, TX (US); Jeff Watts, Fort Worth, TX (US)

(72) Inventors: Seth Anderson, Fort Worth, TX (US); Jeff Watts, Fort Worth, TX (US)

(21) Appl. No.: 13/565,441

(22) Filed: Aug. 2, 2012

Related U.S. Application Data
(60) Provisional application No. 61/514,569, filed on Aug. 3, 2011.

(51) Int. Cl. B65D 25/20; B23P 11/00

(52) U.S. Cl. 206/457; 29/428

(57) ABSTRACT

A backpack or other personal article having a changeable ornamental feature. The article includes an exterior surface with loop material affixed to a substantial portion of the exterior surface area of the pack or bag. The user may detachably secure patches or other objects to the surface of the backpack or personal article with hook and loop fastener material, providing a mechanism by which the user may accessorize and personalize their personal articles.

### CROSS-REFERENCE TO RELATED APPLICATIONS

This application claims the benefit of provisional Application No. 61/514,569, filed Aug. 3, 2011.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to handbags, backpacks, and cases, and more specifically to an apparatus for decorating same with removable patches and other artworks or images.

2. Description of Related Art Including Information Disclosed under 37 CFR 1.97 and 1.98

The recent trend of fashion has impacted the market of bags, whether it is a purse, a backpack, a knapsack, a lunch box, etc. A person wants more features than just one look with each backpack. For example, many young children who are sports fans cheer for more than one team. Many kids have a favorite football team, a favorite basketball team, and a favorite baseball team. The favorite sports team changes with the season, so the child may want the baseball team backpack in the summer, the football backpack in the fall, and the basketball backpack in the winter. Each backpack is costly by itself and a parent would not want to buy all three backpacks just to make their child happy.

Also, people can be fickle and change their interests and allegiances from time to time. For example, athletes change teams during the course of their careers and fan loyalty will change accordingly. The fan must then spend additional money for new apparel or articles (e.g. a backpack or lunch box) emblazoned with a particular team logo and discard their old articles in favor of their new favorite team. In a similar vein, fashion accessories (e.g. purses) are constantly evolving and over time a certain style or accessory will become out of fashion and no longer desirable.

A person can also save money by buying one backpack and then altering the appearance of same every time they change their interests or fashion dictates for different occasions. A person could sew patches on a backpack, but affixing and removing them can be quite time consuming and require sewing skills. Moreover, if a person's allegiance changes to another team then one must cut off former sports club's patch or insignia leaving the backpack scarred where the prior patch was sewn to the pack. Changing patches several times leaves perforated surfaces on the backpack and causes the pack material to weaken and lose strength resulting in an undesirable appearance and potential structural failure. If a person could quickly affix and remove artwork and other ornamental designs to their backpack, that person could reuse the backpack for years even though they have changed their interests or brand loyalties and want the accessorize the backpack to look differently on various occasions.

Backpacks have become a part of the fashion industry. Many fashion designers develop backpacks and handbags as fashion accessories to accompany many outfits. A person who has several different outfits and color combinations of clothes would prefer a specific colored backpack or bag to accessorize their outfit. As are result, a person would have to own several backpacks: a brown or blue one for those colored outfits, a black one for black style outfits, and maybe a bold colored one such as red for bright outfits. It would be more economical to have a single backpack or bag that could be accessorized with removable patches or panels that could be decorated to accessorize with one's personal fashion style.

Therefore, a need exists in the art for a pack or bag on which the user may attach and detach various patches or other types of decoration without damaging the surface or structural integrity of the pack or bag. Further, a need exists for a more economical backpack or bag that can be accessorized with removable patches or panels to fit one's personal fashion style. The invention disclosed herein satisfies such needs. Other technical advantages of the present invention will be readily apparent to one skilled in the art from and understanding of the following figures, descriptions and claims. While specific advantages and embodiments have been enumerated above, various embodiments may include all, some, or even none of these enumerated advantages.

### BRIEF SUMMARY OF THE INVENTION

The present invention includes an ornamentally variable portable container for personal items, the container comprising: at least one visible surface, the visible surface including a first component of a reusable fastener system upon which one or more ornamental features may be removably attached. Additional variations may include at least one ornamental feature, the ornamental feature including a second component of a reusable fastener system that corresponds to the first component, wherein the ornamental feature may be removably attached to the at least one visible surface by action of the first and second components of the reusable fastener system. Additional variants are described and claimed herein.

In another embodiment the present invention includes an ornamentally variable portable container for personal items, the container comprising: at least one visible surface, the visible surface including a first component of a reusable fastener system upon which one or more ornamental features may be removably attached; and at least one ornamental feature, the ornamental feature including a second component of a reusable fastener system that corresponds to the first component, wherein the ornamental feature may be removably attached to the at least one visible surface by action of the first and second components of the reusable fastener system. Additional variants are described and claimed herein.

In another embodiment the present invention teaches a method for providing variable ornamentality of a portable container for personal items, the method steps comprising: attaching a first component of a reusable fastener system to at least one visible surface of a container for personal items; providing one or more ornamental features, the ornamental features including a second component of a reusable fastener system corresponding to the first component; and attaching the ornamental features to the at least one visible surface by action of the first and second components of the reusable fastener system. Additional variants are described and claimed herein.

### BRIEF DESCRIPTION OF THE SEVERAL VIEWS OF THE DRAWING(S)

Various aspects of the invention, as well as an embodiment, are better understood by reference to the following detailed description. The detailed description, given by way of examples and not intended to limit the present invention solely thereto, will be better understood when read in conjunction with the drawings wherein like reference numerals denote like elements and parts in which:

FIG. 1 is a perspective view of an embodiment of the invention disclosed herein depicting a backpack with the shoulder straps, the rear of the backpack and several patches affixed thereto;

FIG. 2 is a front view of an embodiment of the invention disclosed herein showing the backpack worn by a user with decorative patches;

FIG. 3 is a perspective view of one embodiment of the invention disclosed herein showing the user removing a patch from the surface of a backpack;

FIG. 4 is a perspective view of an embodiment of the invention disclosed herein depicting a laptop case being worn by a user and decorated with various decorative patch designs;

FIG. 5 is a perspective view of an embodiment of the present invention depicting a purse being worn by a user and decorated with various patch designs;

FIG. 6 is a perspective view of an embodiment of the present invention depicting a lunch box being carried by a user and decorated with a patch design; and

FIG. 7 is a perspective view of an embodiment of the present invention depicting a notebook trapper/keeper being carried by a user and decorated with various patch designs.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

For purposes of teaching and discussion, it is useful to provide some overview as to the way in which the invention disclosed herein operates. The following information may be viewed as a basis from which the present invention may by properly explained. Such information is offered for purposes of explanation only and, accordingly, should not be construed to limit the broad scope of the present invention and its potential applications.

The present invention can take many forms and be utilized on a variety of portable containers for personal items, including but not limited to a backpack, a laptop case, a purse, a lunchbox, and a notebook trapper/keeper case. The backpack embodiment disclosed herein will be discussed in detail, although it is readily known to one of ordinary skill in the art that the same teachings will apply to the vast array of bags, purses, and other packs which a user may utilize to transport desired articles or goods.

Backpacks have many various uses and are quite popular due to their variable functionality in carrying various cargos and dispersing the weight of such cargo on the user's shoulders. In recent times, backpacks have also gained certain fashion appeal. Backpacks have been and currently are made by famous designers and can be very expensive. The fashion appeal can be coordinated and personalized with specific colors and/or specific designs. The present invention increases the fashion utility and ornamentality of the backpack, but does not affect or decrease the functionality of the pack. The invention disclosed herein uses a reusable fastener system, in one embodiment hook and loop material, to enable the attachment and removal of design patches and other ornamental designs to alter the look of the backpack. Hook and loop material is preferred for the fastening material as it allows for repeated fastening and removal, and is easy to use, safe, and maintenance free. There is only a minimal decline in fastening strength even after numerous iterations of fastening and unfastening operations between the pack and decorative decal patch.

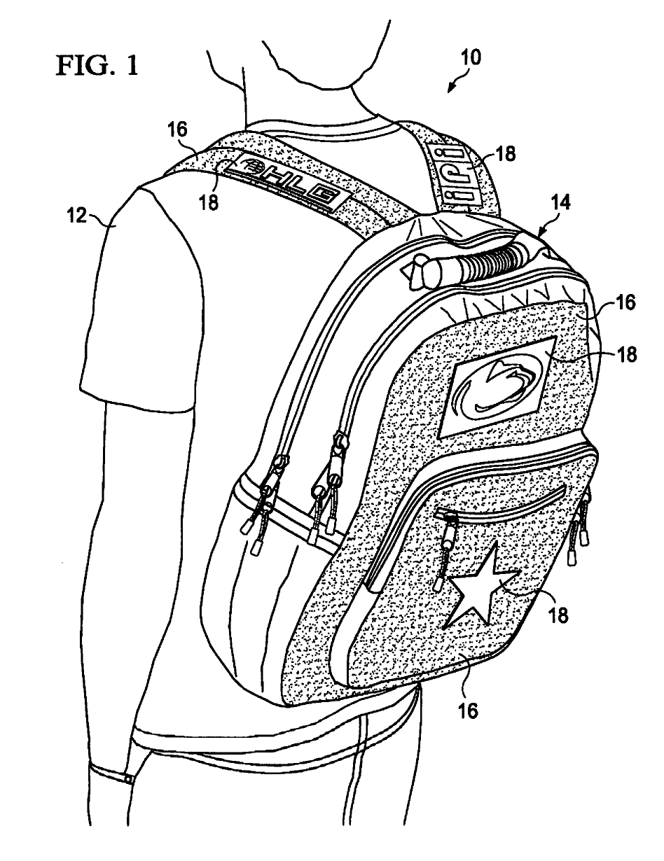

Turning to FIG. 1, a rear view of the backpack 10 embodiment disclosed herein is shown. The backpack 10 includes a cargo compartment or sack attached to a pair of shoulder straps. The straps may be adjustable and include a chest band in certain embodiments. The backpack as described thus far may be conventional in design and construction such as nylon, leather, cordura or other known materials known in the art. A user 12 wears the backpack 10 by putting his arms through the shoulder straps as shown. In one embodiment, the exterior surface and shoulder straps of the backpack 10 have loop material 16 attached to a substantial portion of the exterior visible surface of the backpack and shoulder straps as shown. The loop material 16 is soft to the touch and can be made of many colors including black, white, brown, and blue. In one embodiment, the loop material 16 can be sewn into the backpack 10 as a component of the pack 10. In various embodiments, the loop material 16 may be sewn on to the existing backpack 10 exterior surfaces as preferred by the manufacturer or user. In the embodiment shown in FIG. 1, the loop material 16 is located on the topside of the shoulder straps and on the outer rear side of the backpack 10. On top of the backpack 10, a carry handle 14 is attached so the user 12 may carry the backpack by hand instead of by the shoulder straps. The handle 14 adds another level of functionality to the use of the backpack 10.

Patches 18 or other removably-attachable ornamental features (for example, patches, decals, badges, emblems, tokens, or the like) are shown affixed to the various exterior surface areas of backpack 10. Patches 18 include hook material on a surface of the patch 18 which allow the user 12 to affix the patches 18 to the backpack 10 by mating the hook and loop materials together. These patch designs may include artwork, a favorite team logo, or other design as preferred by the user 12. Additional designs and logos can be substituted for those shown in FIG. 1. Patches 18 are removable which allows the user to alter the ornamental appearance of the backpack with by changing the patches or changing the patch locations on the backpack.

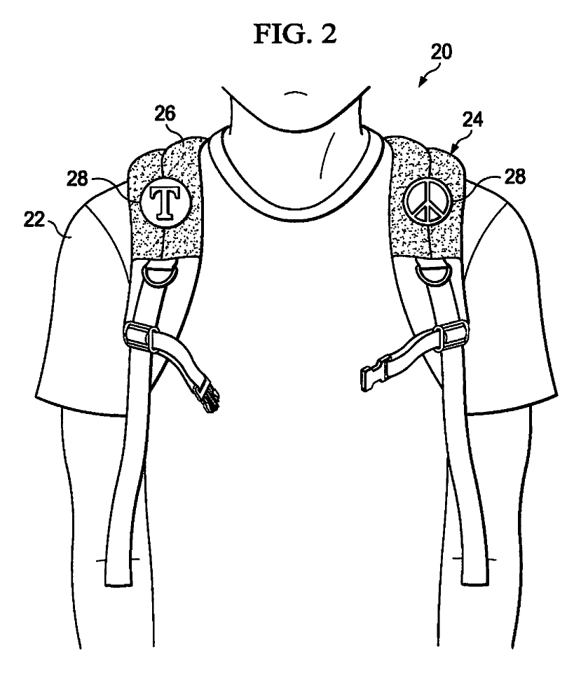

Turning to FIG. 2, the pack 20 is shown being worn by the user 22. As shown in this embodiment, loop material is shown on straps 24 and 26. Patches 28, with hook material affixed to the back thereof, are shown attached to straps 24, 26. Replacing the patches 28 with different patches allows the user 20 to alter the appearance and ornamental appeal of the backpack thereby increasing its versatility and usability in different environments.

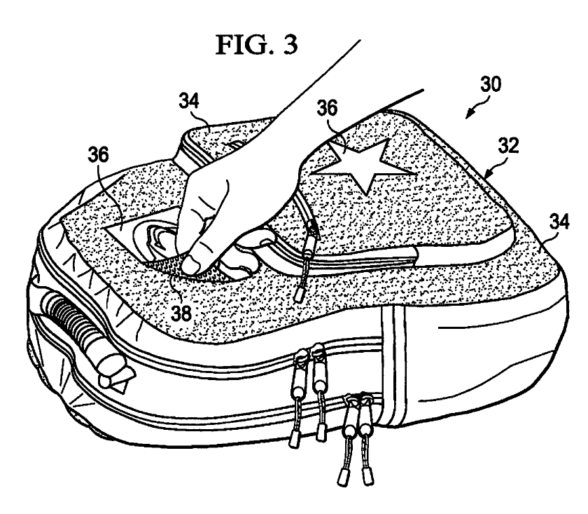

FIG. 3 depicts a backpack 30 with a user shown removing a patch 36 from the backpack 30. As previously described herein, patch 36 includes hook material 38 on a surface of patch 36, which in the embodiment shown is the back surface of patch 36. The user simply peels the patch 36 away from the loop material 34 and the patch 36 is removed. The user may replace the patch 36 on another location of backpack 30 by pressing the patch 36 on to the loop material 36 located on backpack 10. The loop material 34 then mates or locks with hook material 38 and affixes the patch 36 to the backpack 30. Alternatively, the user may affix a new patch (not shown) to the backpack by simply pressing the hook and loop material as described herein so as to affix the new patch to the backpack.

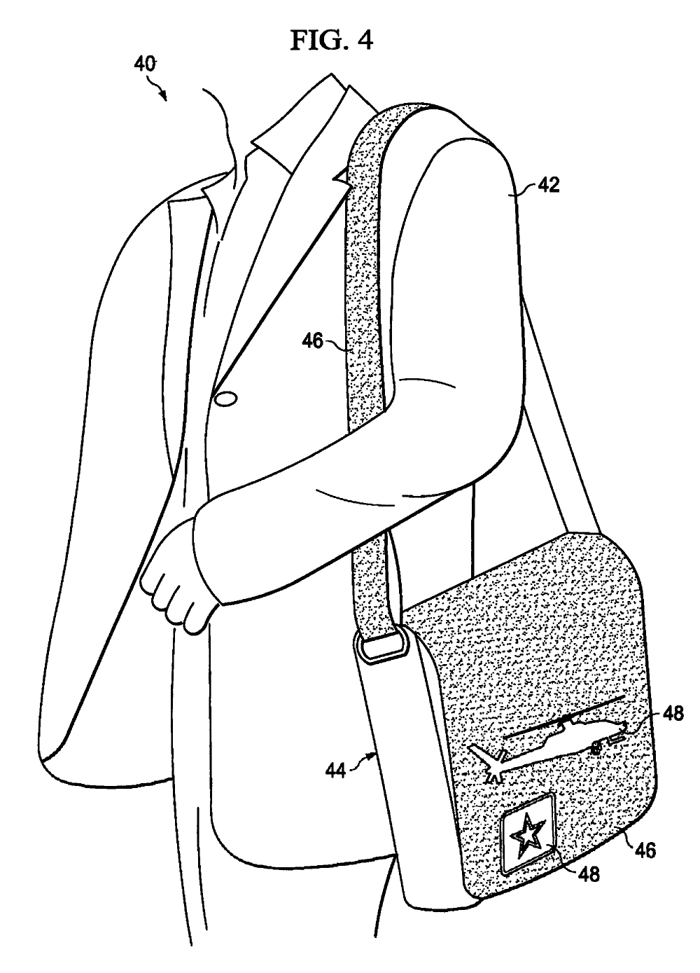

FIG. 4 shows a perspective view of a shoulder or messenger bag embodiment 40 of the present invention. A user 42 wears the shoulder bag 40 on one shoulder 42 via one strap. Each end of the strap connects and supports the bag 44 at each side of the bag accordingly. The strap and bag visible surfaces include loop material 46 as shown and which allows the user 42 to secure various ornamental patches and designs 48 (which have hook material on a surface not shown) to the strap and bag surfaces giving the shoulder bag 40 personalized, fashion appeal.

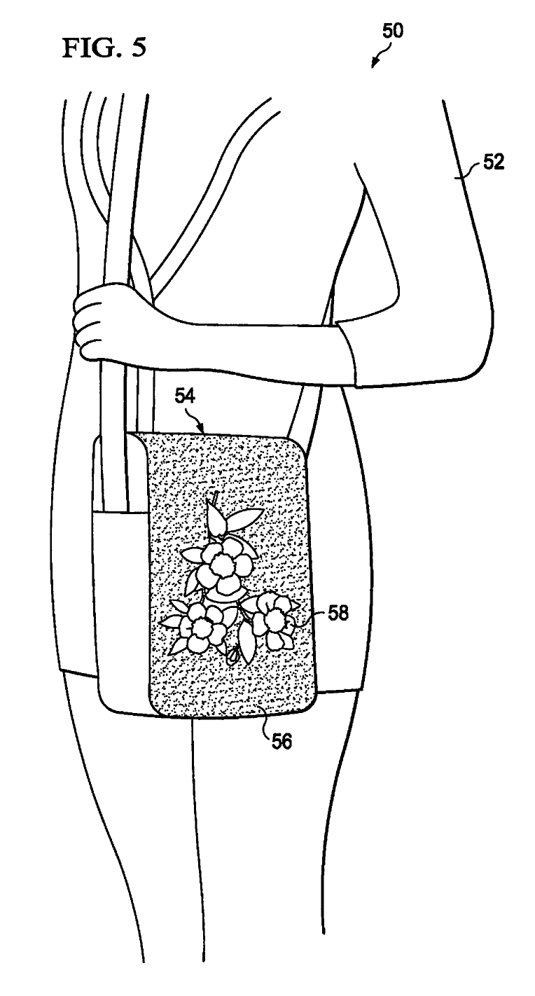

FIG. 5 discloses an embodiment of the invention disclosed herein which comprises a purse 50 embodiment. The purse 50 design is similar to the shoulder messenger bag design shown in FIG. 4. The purse 50 can be one of several shaped designs. In the depicted example, a box-style purse is shown, although various other styles such as round, small hand purses, or beach bag purses may use the inventive disclosure described herein. Purse 50 includes a cover flap 54 that includes loop material 56 on the visible surface as shown. The cover flap 54 is secured via a snap button, but alternative fasteners such as a button, Velcro, or a tie may be used. A user 52 carries the purse 50 by a strap that fits over the user's shoulder. In the depicted embodiment, the user 52 has attached a floral patch 58 to the loop material 56. Floral patch 58 includes hook material (not shown) on the back surface of the patch 58 so as to provide a fastening mechanism as previously described herein.

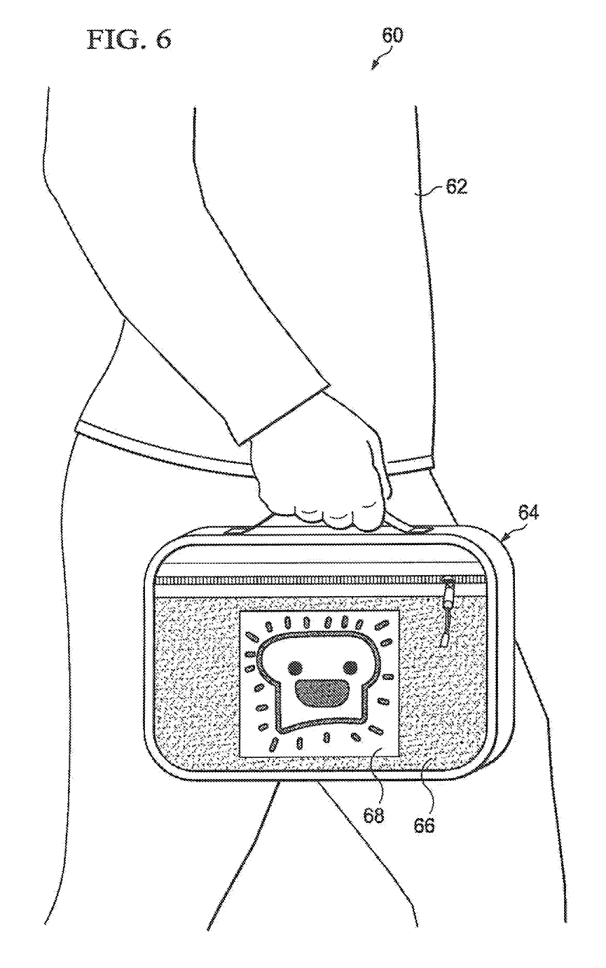

FIG. 6 discloses an embodiment of the invention described herein comprising a soft lunch box 60. A user 62 carries the lunchbox 64 as shown. Lunchbox 64 includes loop material 66 on the surface of lunchbox 64. As described herein, the user 62 may affix patch 68 to the lunchbox 64 by pressing patch 68 (which has hook material located on the back surface of the patch 68) on to the surface of loop material 66. In various embodiments, the loop material 66 may be included on different or all of the various external surfaces of the lunchbox 64. Likewise, patch 68 may be removed and replaced with an alternative patch design as desired by the user.

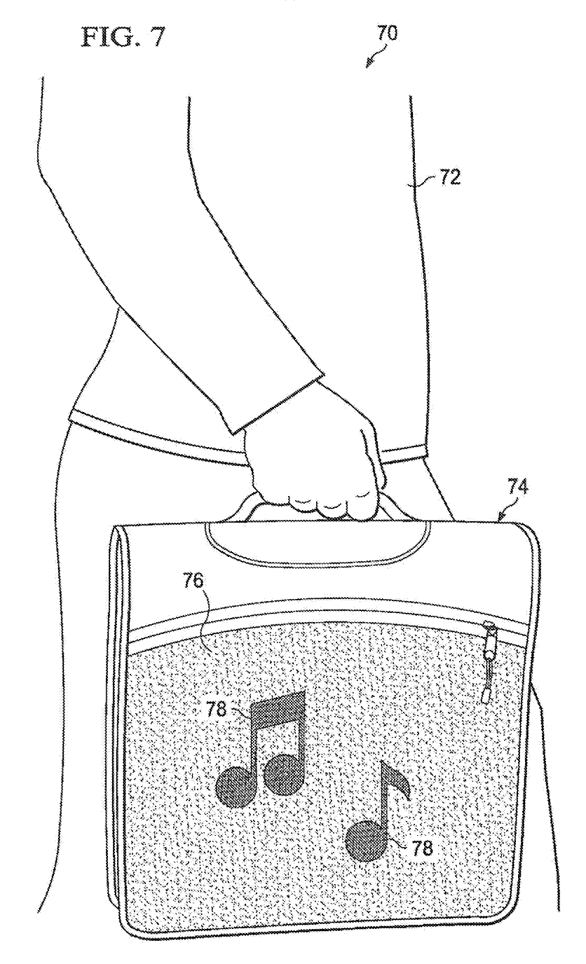

Turning to FIG. 7, an alternative embodiment of the present invention is disclosed comprising a notebook “trapper/keeper” 70 for storing school supplies. Notebook case 74 may include a binder ring and various compartments for storing school supplies and papers. On the outer visible surface of the notebook 74 loop material 76 is located as shown. User 72 may decorate her notebook 74 by affixing patch designs 78 as shown. User 72 may remove patches 78 and affix new patches (not shown) according to her preference and as described herein. As previously discussed, patches 78 have hook material located on the back surface of the patches 78 which provide the fastening mechanism for securing the patches 68 to the notebook 74. The note patches 68 add an ornamental appeal to the CD case 64. The patches can be removed and replaced with alternative patches such as musical group logos.

The use of the hook and loop fastener materials allows the user to easily attach and remove various decorative patches or emblems on their personal articles. However, it is contemplated that other fastening means as is known in the art could be utilized to effect the purposes of the invention. Magnetic, snap and other known fastening means may be utilized as would be recognized by one of ordinary skill in the art. For example, another embodiment utilizes a magnetic plate sandwiched between the layers of fabric that constitute the exterior of the personal item container. Magnets attached to the decorative patches or emblems may then adhere to the magnetic plate, yet allow for removal, rearrangement, or replacement as desired. Further, the magnet can be a permanent magnet or an electromagnet that, for example, is powered by a battery. An embodiment utilizing an electromagnet also allows for the electricity to power LEDs to further the unique ornamentally variable nature of the apparatus. Likewise, the backpacks and other personal articles may be constructed of various materials including but not limited to leather, plastic, nylon, cordura, or the like as is otherwise known by those of ordinary skill in the art.

The invention disclosed herein facilitates the personalization of one's personal articles and enables reuse of the article while allowing the user to design and express their personality and tastes. Each of the disclosed embodiments has changeable appearances that allow the embodiment to be adapted to coordinate with a user's clothing and/or or personality. This adaptability allows each of these embodiments to change with the contemporary societal appeal. A user can utilize the same bag for several years while maintaining fashionable appeal as fashion trends evolve.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. While various alterations and permutations of the invention are possible, the invention is to be limited only by the following claims and equivalents.

We claim:

1. An ornamentally variable portable container for personal items, the container comprising:
at least one visible surface, the visible surface including a first component of a reusable fastener system upon which one or more ornamental features may be removably attached.

2. The container of claim 1, the container further comprising:
at least one ornamental feature, the ornamental feature including a second component of a reusable fastener system that corresponds to the first component, wherein the ornamental feature may be removably attached to the at least one visible surface by action of the first and second components of the reusable fastener system.

3. The container of claim 1, the container further comprising:
at least one ornamental feature, the ornamental feature including a second component of a reusable fastener system that corresponds to the first component, wherein the ornamental feature may be removably attached to the at least one visible surface by action of the first and second components of the reusable fastener system,
wherein the reusable fastener system is a hook and loop fastener material.

4. The container of claim 1, the container further comprising:
at least one ornamental feature, the ornamental feature including a second component of a reusable fastener system that corresponds to the first component, wherein the ornamental feature may be removably attached to the at least one visible surface by action of the first and second components of the reusable fastener system,
wherein the reusable fastener system comprises a magnet and a magnetic material, wherein the first component is either a magnet or a magnetic material and the second component is the compliment of the first component.

5. The container of claim 1, the container further comprising:
at least one ornamental feature, the ornamental feature including a second component of a reusable fastener system that corresponds to the first component, wherein the ornamental feature may be removably attached to the at least one visible surface by action of the first and second components of the reusable fastener system,
wherein the reusable fastener system is a snap fastener having two separate components.

6. An ornamentally variable portable container for personal items, the container comprising:
at least one visible surface, the visible surface including a first component of a reusable fastener system upon which one or more ornamental features may be removably attached; and
at least one ornamental feature, the ornamental feature including a second component of a reusable fastener system that corresponds to the first component, wherein the ornamental feature may be removably attached to the at least one visible surface by action of the first and second components of the reusable fastener system.

7. The container of claim 6, the reusable fastener system chosen from the group consisting of hook-and-loop, snap, and magnet fasteners.

8. A method for providing variable ornamentality of a portable container for personal items, the method steps comprising:
attaching a first component of a reusable fastener system to at least one visible surface of a container for personal items;
providing one or more ornamental features, the ornamental features including a second component of a reusable fastener system corresponding to the first component; and
attaching the ornamental features to the at least one visible surface by action of the first and second components of the reusable fastener system.

9. The method of claim 8, the method steps further comprising:
providing one or more additional ornamental features, the additional ornamental features including the second component of a reusable fastener system; and
attaching the additional ornamental features to the at least one visible surface by action of the first and second components of the reusable fastener system.

10. The method of claim 8, the method steps further comprising:
providing one or more additional ornamental features, the additional ornamental features including the second component of a reusable fastener system;
removing the one or more ornamental features from the at least one visible surface; and
attaching the additional ornamental features to the at least one visible surface by action of the first and second components of the reusable fastener system.

11. The method of claim 8, wherein the first and second components are substantially not visible when attached.
